(19) United States
(12) Patent Application Publication
(10) Pub. No.: US 2015/0099152 A1
(43) Pub. Date: Apr. 9, 2015

(54) method for connecting poles of battery cells

(71) Applicant: Robert Bosch GmbH, Stuttgart (DE)

(72) Inventors: Christoph Bantel, Ditzingen (DE); Heinz Neubert, Albershausen (DE); Reiner Ramsayer, Rutesheim (DE); Friedheim Guenter, Burgstetten (DE); Sonja Dudziak, Bietigheim-Bissingen (DE)

(21) Appl. No.: 14/396,704

(22) PCT Filed: Mar. 21, 2013
(86) PCT No.: PCT/EP2013/055906

§ 371 Date: Oct. 23, 2014

(30) Foreign Application Priority Data
Apr. 25, 2012 (DE) 10 2012 206 830.9

(51) Int. Cl. H01M 2/20; B23K 26/08; B23K 26/32

(52) U.S. Cl. CPC H01M 2/206; B23K 26/3213; B23K 26/0807
USPC 429/121; 219/56.22

(57) ABSTRACT

A method for connecting poles of two battery cells includes using a connecting element, which is configured as a stranded wire and connects the poles of the battery cells to one another. The stranded wire is connected directly to a pole of a battery cell in a welding area with a laser beam for forming a laser beam weld.

### FIELD OF THE INVENTION

The present invention relates to a method for connecting poles of battery cells.

### BACKGROUND INFORMATION

In recent time, the connection of poles of battery cells has come more and more into focus, in particular due to the use of battery cells in hybrid vehicles. One object is to electrically connect the single cells, which are typically arranged inside a battery module, to one another and in turn to assemble or connect the battery modules on their part to one another to form an overall power source. In particular, it is desirable that, for example, mechanical loads on the individual battery cells in the battery modules or on the battery modules do not result in an impairment of the connection between the individual poles of the battery cells or between the battery modules. Therefore, an electrical connection between the battery poles which is elastic to some extent is desirable.

For this reason, for example, a method for connecting poles of battery cells is discussed in DE 10 2009 024 513 A1, in which a connecting element is provided, which includes a section implemented as a stranded wire and rigid and plate-shaped terminal elements, which are connected to the particular stranded wire ends. The terminal elements are in turn connected to the poles of the battery cells. Aluminum stranded wires, copper stranded wires, aluminum braids, or copper braids are provided as the stranded wires. Furthermore, it is described in the cited document that the terminal elements, i.e., the plate-shaped areas of the connecting element, are connected to the battery poles by a laser welding method. The connecting elements known from the mentioned document are relatively complex to manufacture due to their multipart implementation (stranded wire and plate-shaped terminal elements).

A further method is discussed in DE 10 2008 035 169 B3, in which, proceeding from a stranded wire-shaped connecting element, contacting plates are provided, which are in turn connected to the battery poles of the battery cells. A stranded wire which extends over all poles of the battery cells is used here, it being provided that the connecting areas between the stranded wire and the contacting plates are manufactured by ultrasonic welding, whereby a homogeneous connection having what may be a low transition resistance is to be provided. The connecting element known from the last-mentioned document is also relatively complex and therefore costly due to its multipart implementation.

### SUMMARY OF THE INVENTION

The present invention is based on the object of refining a method for connecting poles of battery cells according to the description herein in such a way that a particularly cost-effective connection is achieved between the individual battery cells, with good electrical properties. This object is achieved according to the present invention in a method for connecting poles of battery cells having the features described herein in that the stranded wire in the terminal area of an electric pole of the battery cell is connected in a welding area using a laser weld. In other words, this means that the method according to the present invention only still has one stranded wire as a single connecting element as the connecting element, so that method steps which relate to the connection of the stranded wire to (plate-shaped) elements for connecting the stranded wire to the battery poles according to the related art may be saved. A particularly simple and cost-effective connection between the poles of the battery cells is thus made possible.

Advantageous refinements of the method according to the present invention are set forth in the further descriptions herein. All combinations of at least two features provided in the claims, the description, and/or the figures fall within the scope of the present invention.

To achieve what may be a low transition resistance between a pole of a battery cell and the stranded wire, an extensive or integrally joined connection is necessary between the stranded wire material and the pole of the battery cell. Due to the configuration of the stranded wire, in the case of which it is typically made of a wire braid, which is made of a plurality of individual wires, air enclosures are situated between the individual wires, which impair a secure connection between the stranded wire or the stranded wire material and the pole of the battery cell and also the fusion of the material.

For this reason, it may be provided that during the formation of the laser weld between the stranded wire and the pole of the battery cell, the laser beam is moved oscillatingly in the weld area. An oscillating movement is understood as a back-and-forth movement of the laser beam which may take place in principle both in an advance direction of the laser beam, and also perpendicularly or at an angle to the advance direction. In particular the air enclosures between the individual wires of the stranded wire may be expelled to some extent by the oscillating movement of the laser beam, so that a particularly good heat transfer and heat input are generated by the laser beam, which results in a good fusion of the material of the stranded wire and the pole of the battery cell and therefore a high-quality welded joint.

In a variant of the movement of the laser beam, it is provided that the laser beam is moved oscillatingly perpendicular to the advance direction of the laser beam. With relatively short process times, a relatively broad weld seam is thus produced, which has a low electrical resistance due to its large area.

To improve the welded joint, it may additionally be provided that the laser beam passes over the weld seam multiple times. In particular relatively uniform heating of the welded area may thus take place, because thermal tension peaks are avoided or reduced during the production of the weld seam.

In particular, a stranded ribbon wire may be used as the stranded wire. Such a stranded ribbon wire has (in contrast to a stranded wire which has a round cross section) a relatively small thickness in relation to its width, so that relatively small energy inputs into the stranded ribbon wire already enable an integral joint between the stranded wire and the pole of the battery cell, since the laser beam must only heat up a relatively thin material layer (of the stranded ribbon wire).

With regard to the device, the welded joints, which are produced by the laser beam, may be manufactured particularly precisely and easily if the laser beam is moved by an optical device. This optical device ensures the required advance movement of the laser beam, on the one hand, and at the same time (if provided) ensures the oscillating movement of the laser beam, on the other hand.

The present invention is capable both of electrically connecting individual battery cells within a battery module to one another, and electrically connecting battery poles of battery modules to be connected to one another.

Further advantages, details, and features of the present invention result from the following description of exemplary embodiments and on the basis of the drawings. Identical components or components having an identical function are provided with identical reference numerals in the figures.

### BRIEF DESCRIPTION OF THE DRAWINGS

FIG. 1 shows a simplified view of a battery unit, which is made of multiple battery modules, each having multiple battery cells, the poles of which are connected to one another using stranded wires.

FIG. 2 shows a top view of the connection area of two poles of adjoining battery cells according to FIG. 1.

FIG. 3 shows the welded area on one pole of a battery cell in an enlarged detail view to explain the oscillating movement of the laser beam.

FIG. 4 shows a simplified view of a laser beam device for use in a method according to the present invention.

### DETAILED DESCRIPTION

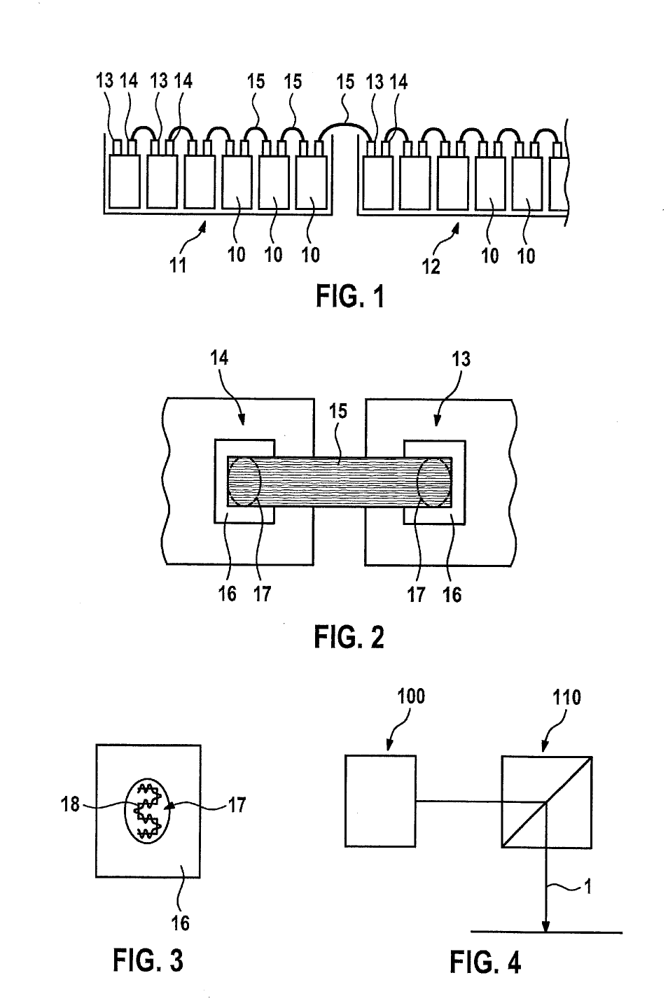

FIG. 1 shows two battery modules 11, 12 situated adjacent to one another as an example, as they may be, but not restrictively, used as a component of a power supply unit in a hybrid vehicle. Of course, it may also be provided that such a power supply unit includes more than two battery modules 11, 12. Each of battery modules 11, 12 contains multiple battery cells 10, which may be configured identically, it being presumed as an example and in simplified form that six battery cells 10 are situated adjacent to one another in battery module 11. In addition, it is explained that such a power supply unit in a hybrid vehicle may include a total of approximately one hundred battery cells 10, which are allocated to corresponding battery modules 11, 12.

Each battery cell 10 has a positive pole 13 and a negative pole 14. It is presumed as an example that individual battery cells 10 in battery modules 11, 12 are connected to one another in series, i.e., in each case one positive pole 13 of a first battery cell 10 is electrically connected to one negative pole 14 of a second battery cell 10. Battery modules 11, 12 may in turn also be electrically connected in series or in parallel.

The connection at least between individual poles 13, 14 between two battery cells 10 in a battery module 11, 12, but may also the electrical connection between two battery modules 11, 12, is established with the aid of stranded wires 15, which are used as connecting elements. Stranded wires 15 may be at least essentially made of copper or aluminum and have a plurality of individual wires (strands) which are interwoven in the form of a wire braid or the like. Stranded wires 15 may each be configured as flat stranded wires, i.e., they have a rectangular cross section having a relatively large width and a relatively small thickness in relation to the width. Not only is the electrical connection established between individual battery cells 10 or battery modules 11, 12 with the aid of stranded wires 15, but rather stranded wire 15 is also used for a (flexible) movement compensation between individual battery cells 10 or between battery modules 11, 12.

It is presumed as an example that poles 13, 14 have connection areas 16 (FIG. 2), which are made of a material or are implemented in such a way that a welded joint may be formed with the aid of a laser beam 1 between particular connection areas 16 and stranded wire 15. Laser beam 1 is generated according to FIG. 4 with the aid of a laser beam device 100, the position of laser beam 1, at least in connection area 16, being able to be changed in the plane of connection area 16 or the movement of laser beam 1 being able to be controlled with the aid of a scanner optic 110.

By fusing the material of stranded wire 15 and connection area 16 in a welding area 17 by way of laser beam 1, the desired integral joint between stranded wire 15 and connection area 16 of battery cell 10 is established. In FIG. 3, connection area 16 and welded area 17 on a battery cell 10 are shown in greater detail; the depiction of stranded wire 15 was omitted. It is recognizable in this case that laser beam 1 has a serpentine advance path 18 overlapping with stranded wire 15, around which laser beam 1 is moved back and forth oscillatingly. A large-area heating of the material of stranded wire 15 and connection area 16 in welding area 17 is achieved by such a movement of laser beam 1. In the illustrated exemplary embodiment, laser beam 1 is moved oscillatingly perpendicularly to the advance direction of laser beam 1. However, it is also conceivable that laser beam 1, in relation to the advance direction of laser beam 1, is moved back and forth in the longitudinal direction of advance path 18. It is essential that air enclosures present inside the wire braid of stranded wire 15 may be expelled by the described oscillating movement of laser beam 1, so that a particularly good heat transfer of laser beam 1 to stranded wire 15 and connection area 16 is achieved. It is therefore sufficient to position or press stranded wire 15 using a relatively small hold-down force or application force on connection area 16, to establish the desired integral joint between stranded wire 15 and poles 13, 14 of battery cell 10.

The above-described method may be altered or modified in manifold ways without deviating from the idea of the present invention. In particular, the selection of suitable laser beam device 100 and of the material used for stranded wire 15 and the geometric dimensioning thereof are dependent on the particular application. The shape and size of the welded joint between stranded wire 15 and connection area 16 will possibly also have to be selected differently from case to case. It may also be provided that laser beam 1 passes over welding area 17 between stranded wire 15 and connection area 16 multiple times.

1-10. (canceled)

11. A method for connecting poles of two battery cells, the method comprising:
providing a connecting element, which is includes a stranded wire and which is to connect the poles of the battery cells to one another; and
connecting the stranded wire directly to a pole of a battery cell in a welding area with a laser beam for forming a laser beam weld.

12. The method of claim 11, wherein the laser beam is moved oscillatingly in the welding area.

13. The method of claim 12, wherein the laser beam is moved oscillatingly perpendicularly to the advance direction of the laser beam.

14. The method of claim 12, wherein the laser beam passes over the welding area multiple times.

15. The method of claim 11, wherein a stranded ribbon wire having a rectangular cross section is used as the stranded wire.

16. The method of claim 11, wherein the stranded wire is made at least essentially of copper or aluminum.

17. The method of claim 12, wherein the laser beam is moved by an optical device.

18. The method of claim 11, wherein battery cells of a battery module are connected to one another.

19. The method of claim 11, wherein battery modules, which each have multiple battery cells, are connected to one another.

20. A battery module, comprising:
at least two battery cells; and
a connecting element, which is includes a stranded wire and which connects the poles of the battery cells to one another, wherein the stranded wire is connected directly to a pole of a battery cell in a welding area with a laser beam for forming a laser beam weld.
